(19) United States
(12) Patent Application Publication
(10) Pub. No.: US 2026/0156557 A1
(43) Pub. Date: Jun. 4, 2026

(54) WIRELESS ACCESS POINT BACKHAUL MANAGEMENT IN A NETWORK ENVIRONMENT

(71) Applicant: Charter Communications Operating, LLC, St. Louis, MO (US)

(72) Inventor: Vinayak K. Thotton Veetil, Parker, CO (US)

(73) Assignee: Charter Communications Operating, LLC, St. Louis, MO (US)

(21) Appl. No.: 18/968,761

(22) Filed: Dec. 4, 2024

(51) Int. Cl. H04W 48/06; H04W 28/02

(52) U.S. Cl. CPC H04W 48/06; H04W 28/0231

(57) ABSTRACT

A communication management resource distributes first access configuration settings to a first wireless access point. The first access configuration settings are operative to control selection, by the first wireless access point, of at least one backhaul amongst multiple backhauls available for use by the first wireless access point. In other words, the first wireless access point uses the first access configuration settings as a basis in which to select amongst the multiple backhauls to communicate with a remote. The first wireless access point generates feedback based on the first wireless access point providing multiple mobile communication devices access to the remote network via the first access configuration settings. The first wireless access point communicates the feedback to the communication management resource. Based on the feedback, the communication management resource assigns second access configuration (such as updated first access configuration settings) settings to the first wireless access point.

### BACKGROUND

Conventional wireless networks provide connectivity of mobile communication devices to the Internet via respective wireless access points such as based on wireless protocols including WiFi™, LTE (Long Term Evolution), NR (New Radio), etc.

As an example, assume that a mobile communication device establishes a respective wireless communication link with a first wireless access point. The first wireless access point is coupled to a so-called backhaul that provides connectivity between the first wireless access point and a remote network such as the Internet. Via communications over the respective wireless communication link, and corresponding backhaul, the mobile communication device is able to send/receive data over the Internet.

### BRIEF DESCRIPTION OF EXAMPLES

Example configurations as discussed herein support novel backhaul selection via use of dynamically generated backhaul selection settings.

More specifically, a communication management resource as described herein distributes first access configuration settings (such as backhaul control settings) to a first wireless access point. The first access configuration settings are operative to control selection, by the first wireless access point, of at least one backhaul amongst multiple backhauls available for use by the first wireless access point. In other words, in one example as discussed herein, the first wireless access point uses the first access configuration settings (such as a network policy of backhaul control settings) as a basis in which to select amongst the multiple backhauls to communicate with a remote network. The first wireless access point generates feedback based on use of the first access configuration settings. The feedback may indicate a respective quality level associated with the selected at least one backhauls used to communicate with the remote network.

In one example, the feedback is generated by the first wireless access point based on the first wireless access point providing multiple mobile communication devices access to the remote network via use of the first access configuration settings. The first wireless access point communicates the feedback to the communication management resource.

In a further example, the communication management resource receives feedback from the first wireless access point, where the feedback indicates link/performance quality associated with the one or more backhauls available for use by the first wireless access point as indicated by the first access configuration settings. Based on the feedback, or in response to receiving the feedback, the communication management resource assigns second access configuration settings (such as an updated version of the first access configuration settings or simply new access configuration settings) to the first wireless access point. The second access configuration settings may be assigned as a replacement to the first access configuration settings.

Note that the communication management resource as discussed herein can be configured to modify the first access configuration settings or produce the second access configuration settings (such as backhaul control settings) based on feedback from multiple wireless access points including the first wireless access point. For example, the communication management resource can be configured to generate and communicate the second access configuration settings as a replacement to the first access configuration settings to the first wireless access point in response to second feedback received from a second wireless access point using the multiple backhauls. In one example, the feedback from the second wireless access point indicates a performance of the second wireless access point using a selected at least one backhaul amongst the multiple available backhauls. The one or more backhauls uses by the first wireless access point in accordance with the first access control settings may be the same or different than the one or more backhauls used by the second wireless access point to provide connectivity to the remote network.

In a further example, a group of wireless access points such as including the first wireless access point and the second wireless access point may be assigned the first access configuration settings specifying one or more backhauls for potential selection by each of those wireless access points in the group. Assignment of the second access configuration settings may include assignment of the second access configuration settings to both the first wireless access point and the second wireless access point subsequent to the update based upon feedback from both of the first wireless access point and the second wireless access point.

Note further that the feedback as discussed herein can include any suitable information. For example, the feedback from each respective wireless access point in the group can be configured to indicate a change in use of a selected backhaul by the respective wireless access point to support conveyance of communications associated with multiple mobile communication devices. In another example, the feedback indicates a change in performance of the different one or more selected backhauls.

Still further, the feedback from the wireless access points can be configured to indicate performances of the wireless access point using a set of one or more backhauls selected for use amongst the multiple backhauls.

The first access configuration settings can be configured to include any suitable information. In one example, the first access configuration settings indicate a first ranking of the multiple backhauls available for use by the first wireless access point or any other wireless access point assigned use of the first access configuration settings. The second access configuration settings can be configured to indicate a second ranking of the multiple backhauls, where the second ranking of selectable backhauls is different than the first ranking of selectable backhauls. The different rankings may indicate which of the backhauls are preferred for use such that the wireless access point selects the highest ranked backhauls first. If the highest ranked backhaul is unavailable or provides poor performance to the respective wireless access point, the respective wireless access point can be configured to select a next highest ranked backhaul in received access configuration settings.

As further discussed herein, the communication management resource or other suitable entity can be configured to analyze the feedback received from the first wireless access point to determine a quality of service associated with each of the backhauls as indicated by the access configuration settings. Thus, in one example, the feedback can be configured to indicate a quality of wireless service provided by each of the multiple backhauls. In a further example, in response to detecting that the first access configuration settings are not optimized, the communication management resource can be configured to update the first access configuration settings. In one example, the second access configuration settings are the updated first access configuration settings. Subsequent to updating, the communication management resource or other suitable entity then provides notification of the availability of the updated first access configuration settings (such as the second access configuration settings) to the first wireless access point or other wireless access points in the network environment assigned the updated first access configuration settings as a replacement to the original first access configuration settings.

In yet further examples, the feedback provided by each of the wireless access points indicates a data throughput performance associated with a first backhaul selected by the first wireless access point. The second access configuration settings are assigned to the first wireless access point as the replacement based on the data throughput performance being less than a threshold level. In other words, if the feedback from the first wireless access point and potentially one or more other wireless access points in the group assigned the first access configuration settings indicates that performances associated with the one or more backhauls drops below a respective threshold level, the communication management resource can be configured to modify the access configuration settings as discussed herein.

These and other examples as discussed herein are beneficial because backhaul selection by the one or more wireless access points in the network environment are controlled by a communication management resource, ensuring that a certain level of communication quality is provided to respective mobile communication devices communicating through the respective wireless access point.

Note that any of the resources as discussed herein can include one or more computerized devices, communication management resources, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including computer readable storage hardware (such as hardware to store executable instructions), or non-transitory computer-readable storage media, etc., on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a computer readable storage hardware or medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, examples herein are directed to a method, system, computer program product, etc., that supports operations as discussed herein.

One example as discussed herein includes a computer readable storage medium and/or system having instructions stored thereon to facilitate better use of available wireless resources in a network environment. The instructions, when executed by computer processor hardware, cause the computer processor hardware (such as one or more co-located or disparately processor devices or hardware) to: distribute first access configuration settings to a first wireless access point, the first access configuration settings operative to control selection, by the first wireless access point, of at least one backhaul amongst multiple backhauls available for use by the first wireless access point; receive feedback from the first wireless access point, the feedback generated based on the first wireless access point providing multiple mobile communication devices access to a remote network in accordance with the first access configuration settings; and based on the feedback, assign second access configuration settings to the first wireless access point, the second access configuration settings assigned as a replacement to the first access configuration settings.

Note that the ordering of the steps above has been added for clarity sake. Further note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of network access. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a wireless network environment supporting conveyance of communications between multiple mobile communication devices and corresponding one or more target devices in a network environment as discussed herein.

FIG. 2 is an example flow chart diagram illustrating operations associated with a communication management resource generating backhaul configuration settings supporting backhaul selection associated with multiple wireless access points as discussed herein.

FIG. 3 is an example flow chart diagram illustrating operations associated with a wireless access point receiving assigned backhaul control settings and, based on the receiving backhaul control settings, providing multiple communication devices connectivity to a remote network as discussed herein.

FIG. 4 is an example flow chart diagram illustrating automatic selection of one or more backhauls by a wireless access point to support connectivity between one or more mobile communication devices and a remote network as discussed herein.

FIG. 5 is an example flow chart diagram illustrating manual selection of one or more backhauls by a respective user for use by a wireless access point as discussed herein.

FIG. 6 is an example flow chart diagram illustrating operations associated with a communication management resource updating backhaul configuration settings based on feedback from one or more wireless access points as discussed herein.

FIG. 7 is an example flow chart diagram illustrating updating of one or more network policies (backhaul configuration settings) based on feedback from one or more wireless access points as discussed herein.

FIG. 8 is an example flow chart diagram illustrating a wireless access point monitoring availability of updated access configuration settings as discussed herein.

FIG. 9 is an example flow chart diagram illustrating subscription profile selection being triggered automatically based on receive and d inputs as discussed herein.

FIG. 10 is an example diagram illustrating inputs resulting in the prompt suggesting of better use of the network to a user as discussed herein.

FIG. 11 is an example diagram illustrating implementation of a network environment and corresponding operations as discussed herein.

FIG. 12 is an example diagram illustrating a service bubble representation and storage of a respective information as discussed herein.

FIG. 13 is an example diagram illustrating a wireless network environment supporting conveyance of communications between multiple mobile communication devices and corresponding one or more target devices in a network environment as discussed herein.

FIG. 14 is an example diagram illustrating example computer architecture operable to execute one or more operations as discussed herein.

FIG. 15 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

A communication management resource as discussed herein distributes first access configuration settings to a first wireless access point. The first access configuration settings (such as backhaul control settings or other suitable information) are operative to control selection, by the first wireless access point, of at least one backhaul amongst multiple backhauls available for use by the first wireless access point. In other words, the first wireless access point uses the first access configuration settings as a basis in which to select at least one backhaul amongst the multiple backhauls to communicate with a remote network.

As further discussed herein, the first wireless access point and one or more other wireless access points assigned the first access configuration settings can be configured to generate feedback based on use of the first access configuration settings (such as backhaul control settings). For example, the first wireless access point can be configured to generate the feedback based on the first wireless access point providing multiple mobile communication devices access to the remote network via the first access configuration settings. A second wireless access point can be configured to generate second feedback based on the second wireless access point providing multiple mobile communication devices access to the remote network via the first access configuration settings. The first wireless access point in the second wireless access point communicate the feedback associated with the first access configuration settings to the communication management resource. Based on the feedback, the communication management resource may change the first access configuration settings assigned to the first wireless access point and potentially a group of other wireless access points also assigned use of the first access configuration settings. For example, in response to receiving the feedback, as a substitute to the first access configuration settings, the communication management resource can be configured to assign and send second access configuration settings to the first wireless access point as a replacement to the first access configuration settings.

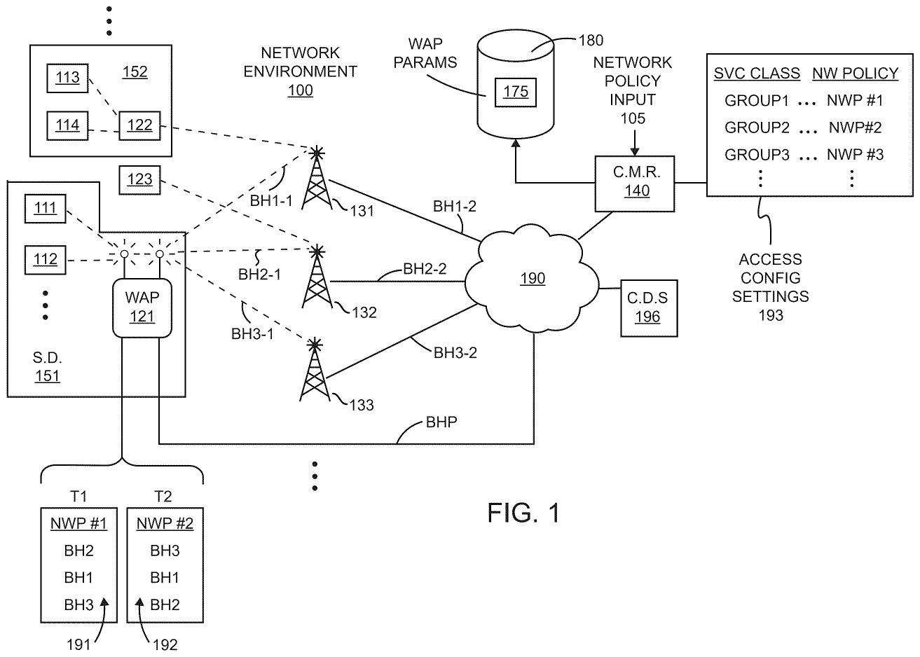

Now, more specifically, with reference to the drawings, FIG. 1 is an example diagram illustrating a wireless network environment supporting conveyance of communications between multiple mobile communication devices and corresponding one or more target devices in a network environment as discussed herein.

In one example, the network environment 100 includes subscriber domain 151, wireless base station 131, wireless base station 132, wireless base station 133, remote network 190, communication management resource 140, repository 180, and communication devices 196. The subscriber domain 151 includes wireless access point 121 providing the one or more mobile communication devices 111, 112, etc., access to the remote network 190 over the one or more backhauls BH1, BH2, BH3.

The network environment 100 can be further configured to include a second wireless access point 122 providing a second set of mobile communication devices 113, 114, etc., access to the remote network 190 using one or more backhauls; the network environment 100 can be further configured to include a third wireless access point 123 providing a third set of mobile communication devices access to the remote network 190 using one or more backhauls; and so on. Thus, the subscriber domain 152 includes wireless access point 122 providing the one or more mobile communication devices 113, 114, etc., access to the remote network 190 over the one or more backhauls BH1, BH2, BH3.

It is further noted that the backhaul BH1 can be configured to include multiple portions such as a first portion backhaul BH1-1 (such as wireless communication link) between the wireless access point 121 and the wireless base station 131. The backhaul BH1 also includes a second portion backhaul BH1-2 (such as wired or wireless communication link) between the wireless base station 131 and the remote network 190. A combination of the first portion BH1-1 and the second portion BH1-2 make up the backhaul BH1.

It is further noted that the backhaul BH2 can be configured to include multiple portions such as a first portion backhaul BH2-1 (such as wireless communication link) between the wireless access point 121 and the wireless base station 132. The backhaul BH2 also includes a second portion backhaul BH2-2 (such as wired or wireless communication link) between the wireless base station 132 and the remote network 190. A combination of the first portion BH2-1 and the second portion BH2-2 makeup the backhaul BH2.

It is further noted that the backhaul BH3 can be configured to include multiple portions such as a first portion backhaul BH3-1 (such as wireless communication link) between the wireless access point 121 and the wireless base station 133. The backhaul BH3 also includes a second portion backhaul BH3-2 (such as wired or wireless communication link) between the wireless base station 133 and the remote network 190. A combination of the first portion BH3-1 and the second portion BH3-2 makeup the backhaul BH3.

It is noted that the backhaul options between the wireless access point 121 and the remote network 190 may further include the physical backhaul BHP. In one example, the physical backhaul BHP is a physical communication link between the wireless access points 121 and the remote network 190.

Additionally, note that the wireless access point 121 and the wireless access point 122 may be assigned the same group identifier value such as GROUP1 and thus corresponding network policy NWP1 to provide respective communication devices access to the remote network 190. For example, in such an instance, the wireless access point 121 uses the network policy NWP1 to select respective backhauls to convey data between the mobile communication devices 111 and 112 over the selected one or more backhaul to the remote network 190. Because the wireless access point 122 is also in GROUP 1, the wireless access point 122 uses the assigned network policy NWP1 to select respective backhauls to convey data between the mobile communication devices 113 and 114 over the selected one or more backhaul to the remote network 190.

As further discussed herein, the network policy assigned to wireless access points in the group GROUP1 may be assigned an updated network policy, in which case, the wireless access point 121 and the wireless access point 122 use the updated network policy of backhaul control settings to implement backhaul selection to provide the continued connectivity of mobile communication devices to the communication devices 196 in the remote network 190.

In this example of FIG. 1, the wireless access point is initially assigned the service class identifier GROUP 1 and corresponding network policy NWP1 at or around time T1. As discussed herein, the communication management resource 140 can be configured to reassign the wireless access point 121 the service class identifier GROUP2 and thus the corresponding network policy NWP2 as a replacement at or around time T2.

Note further that each of the different wireless backhauls BH1, BH2, and BH3 as discussed herein may require use of or assignment of subscriber identity information (such as SIM information or Subscriber Identity Module) for each of the different wireless backhaul options. More specifically, the wireless access point 121 can be configured to use first SIM information (assigned to the wireless access point 121 and/or any of the communication devices 111, 112 or users of those communication devices) to communicate over the wireless communication link BH1-1; the wireless access point 121 can be configured to use the second SIM information (assigned to the wireless access point 121 and/or any of the communication devices 111, 112 for users of those communication devices) to communicate over the wireless communication link BH2-1; and so on.

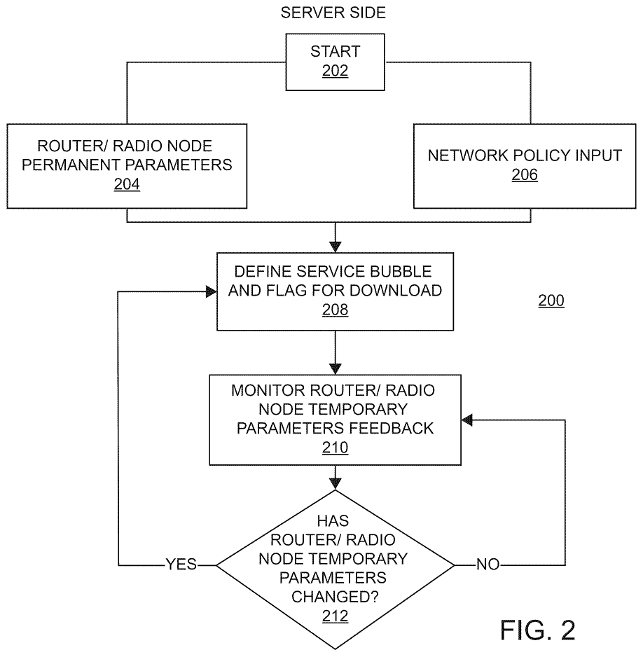

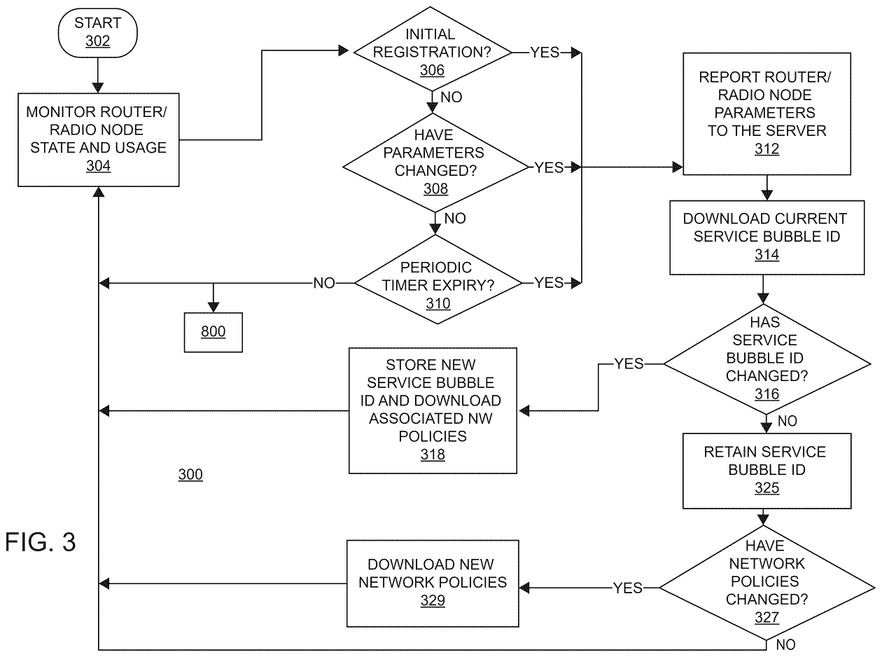

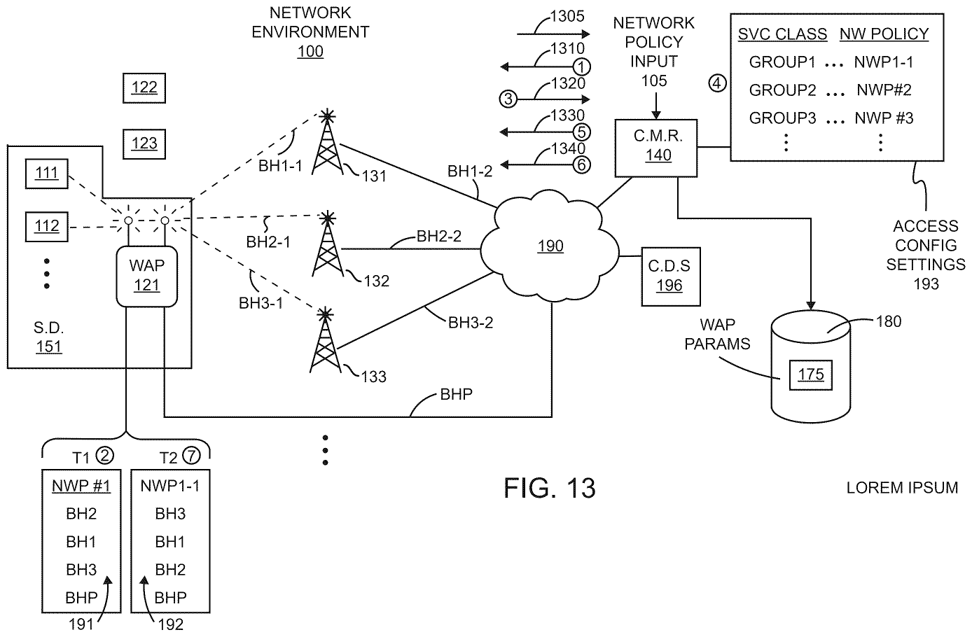

As further discussed herein, each of the wireless access points in the network environment 100 can be configured to execute the flowcharts and corresponding processing operations presented in the following FIGS. 3, 6, and 7. The communication management resource 140 can be configured to execute the flowcharts presented in the following FIGS. 2, 4, 5, and 8. FIG. 13 further describes more particular operations associated with a respective wireless access point 121 implementing different network policies over time such as use of network policy NWP1 for a first time duration and the substitute network policy NWP2 for a second time duration.

FIG. 2 is an example diagram illustrating operations (flowchart 200) associated with a communication management resource generating backhaul configuration settings supporting backhaul selection associated with multiple wireless access points as discussed herein.

In this example, processing operation 202 includes startup of the communication management resource 140.

In processing operation 204, the communication management resource 140 (such as a server resource or other suitable entity) receives wireless access point information or so-called permanent (non-changing) parameters or parameter settings assigned to or associated with each corresponding wireless access point in the network environment such as including one or more parameter settings such as, e.g., device ID information assigned to the wireless access point, device type information assigned to the wireless access point, device capability information assigned to the wireless access point, battery capacity information, memory capacity information, location information indicating where the wireless access is located, wireless data throughput capability associated with the wireless access point, etc.

In one example, the communication management resource 140 receives the permanent information (settings) associated with the corresponding wireless access points during initial registration of each respective wireless access point in communication with the communication management resource 140 or the communication management resource 140 receives the permanent setting information sometime after initial registration of the wireless access point with the communication management resource 140.

In processing operation 206, the communication management resource 140 receives network policy input information from one or more different wireless network service providers. In one example, the network policy information indicates how to produce or adjust the different network policies assigned to the groupings of wireless access points to provide a respective desired level of when quality associated with each of the groupings of wireless access points and corresponding mobile communication devices.

Subsequent to receipt of (in operation 204) permanent parameter information (configuration settings) associated with each of the wireless access points in the network environment 100 as well as receipt of network policy input information 105 (in operation 206) indicating different backhaul services or any services in general to be provided to the corresponding mobile communication devices or subscriber domain, the communication management resource 140 executes the processing operation 208.

In processing operation 208, depending on the permanent parameter settings or characters associated with the wireless access points and the received network policy information, the communication management resource 140 produces and/or assigns a so-called service bubble (network policy) including access configuration settings (a.k.a., backhaul control settings) for each group of wireless access points in the network environment 100.

For example, the communication management resource 140 produces first backhaul control settings (service bubble such as service class #1 and corresponding network policy NWP1) for use by a first group (GROUP #1) of wireless access points in the network environment 100; the communication management resource 140 produces a second backhaul control settings (service bubble such as service class #2 and corresponding network policy NWP2) for use by a second group (GROUP #2) of wireless access points in the network environment 100; the communication management resource 140 produces third backhaul control settings (service bubble such as service class #3 and corresponding network policy NWP3) for use by a third group (GROUP #3) of wireless access points in the network environment 100; and so on.

As further discussed herein, each of the different network policies NWP assigned for use by the different groupings (such as group #1, group #2, etc.) can be adjusted on an as needed basis. For example, as further discussed herein, feedback from each of the wireless access points may indicate that certain backhauls provide very poor performance while other feedback from each of the wireless access points may indicate that certain backhauls provide very good performance. Based on such information, the communication management resource 140 can be configured to modify corresponding backhaul control settings such that the wireless access points in the groupings are provided backhaul performance above a respective threshold level such as indicated by the network policy input 105.

Further, in processing operation 208, note that the communication management resource 140 can be configured to produce multiple sets of backhaul control settings (a.k.a., network policies NWP) which are subsequently assigned for use by different wireless access points in a grouping. In one example, the communication management resource 140 assigns each wireless access point an appropriate set of access configuration settings (backhaul control settings) depending upon the configuration settings assigned to the corresponding wireless access points.

As further discussed herein, the communication management resource 140 can be configured to keep track of the identities of the wireless access points present in the network environment 100. As a new set of backhaul control settings are generated and assigned to a respective wireless access point, the communication management resource 140 can be configured to set a corresponding flag associated with the respective wireless access point. The flag maintained at the communication management resource 140 and assigned to the respective wireless access point notifies the respective wireless access point of a new assignment of a network policy of backhaul control settings for use by that respective wireless access point. Thus, in one example, when a respective wireless access point communicates (to check its flag) with the communication management resource 140 to determine whether any new network policy is available or whether there are any changes to a currently assigned network policy, the wireless access point checks a setting of its corresponding flag assigned to the wireless access point. If the flag is determined to be set as indicated by the respective wireless access point detecting such a condition of the flag, the corresponding wireless access point communicates with the communication management resource 140 to retrieve the newly assigned backhaul control settings.

Thus, based on one or more of received wireless access point permanent parameters, received network policy input information, time information, and default information, the communication management resource 140 sets a flag for download, e.g. sets a flag to indicate to the wireless access point that the wireless access point may download the newly generated backhaul control settings.

As further shown, in processing operation 210, the communication management resource 140 also monitors so-called temporary parameters assigned to each of the wireless access points. The temporary parameters associated with each of the wireless access points may include information such as e.g., backhaul usage information indicating backhauls used use by the wireless access point, signal connectivity information, amounts of use of the selected backhauls and an amount of transmitted data over the selected backhauls, etc.

In processing operation 212, the communication management resource 140 determines whether the so-called temporary parameters/settings assigned to each of the wireless access points has sufficiently changed such that the communication management resource 140 needs to assign a new set or updated set of backhaul configuration settings to one or more of the corresponding wireless access points experiencing the change in parameter settings. For example, if the current network policy of backhaul control settings assigned to the wireless access point 121 does not provide sufficient data throughput capability of conveying communications associated with the communication devices 111, 112, etc., then the communication management resource 140 can be configured to assign a new network policy of backhaul control settings to the wireless access point 121 via processing operation 208.

Thus, in processing operation 212, if the wireless access point temporary parameters/settings have sufficiently changed, e.g., from a wireless access point default value or from last wireless access point reported values, then processing continues at processing operation 208 again, where the communication management resource 140 can be configured to update backhaul control settings assigned to each wireless access point based on any detected changes, which may include assigning the respective wireless access point substitute backhaul control settings or creating new backhaul control settings or a corresponding group of wireless access points. Otherwise processing loops back to processing operation 210.

In processing operation 208, the communication management resource 140 updates one or more of the backhaul control settings or assigns new backhaul control settings to a respective wireless access point or a grouping of wireless access points. This may include setting a corresponding flag, notifying the affected one or more wireless access points of the new backhaul control settings to be used by them to provide connectivity to a remote network 190.

Thus, the implementation of the processing loop including processing operations 208, 210, and 212, ensures that backhaul control settings associated with each of the wireless access points in the network environment 100 are constantly updated as needed with newly assigned backhaul control settings.

In summary, via the flowchart 200, the communication management resource 140 (such as server-side) performs one or more the following operations:
(204) the communication management resource receives Router/Radio node Permanent Parameters
(206) the communication management resource receives network Policy Input
(208) the communication management resource defines service bubble and flag for download
(210) the communication management resource monitors Router/Radio Node (a.k.a., wireless access point) temporary parameters feedback
(212) the communication management resource determines if there is a change to Router/Radio node temporary parameters

FIG. 3 is an example diagram illustrating operations associated with a respective wireless access point retrieving assigned backhaul control settings and, based on the retrieved backhaul control settings, providing multiple communication devices connectivity to a remote network over one or more backhauls as discussed herein.

As shown in flowchart 300 of FIG. 3, processing by a respective wireless access point starts at processing operation 302 such as initialization or power on. This may include the respective wireless access point retrieving default backhaul control settings or implementing a prior retrieved network policy of backhaul control settings from the communication management resource 140.

In one example, at or around a time of executing the processing operation 302, the respective wireless access point resets and then starts a timer that count downs from a maximum time interval value to an expiration time value of 0 (for example, monitoring for occurrence of a timeout duration) for the respective wireless access point to perform the following operations.

In the next processing operation 304 following processing operation 302, the respective wireless access point monitors and keeps track of its usage of the respective backhauls as indicated by its corresponding assigned backhaul control settings (such as network policy which vary depending upon which group the respective wireless access point is assigned).

In processing operation 306, the respective wireless access point determines if it needs to register with the communication management resource 140. If so, processing continues at processing operation 312. If the respective wireless access point has already registered with the communication management resource 140, processing continues at processing operation 308.

As previously discussed, as part of an initial registration process, the respective wireless access point can be configured to generate an initial set of wireless access point parameters and store the generated set of wireless access point parameters as the current set of wireless access point parameters. In processing operation 312, the respective wireless access point can be configured to communicate its wireless access point parameters (such as configuration settings, backhaul usage information, etc.) to the communication management resource 140.

In processing operation 308, the wireless access point determines if its set of stored wireless access point parameters have changed with respect to initial settings at a time of initial registration. If the determination of step 308 is that the set of stored wireless access point parameters/settings associated with the respective wireless access point have changed, then execution of the flowchart 300 continues at processing operation 312. If not, and there is no change associated with parameters of the wireless access point, processing continues at processing operation 310.

Note that processing operation 310 may include determination by the respective wireless access point of whether the timeout duration has occurred. If so, execution continues at processing operation 304 again.

Alternatively, if any of the processing operations 306, 308, 310 results in a positive outcome as detected by the respective wireless access point or other suitable entity, then processing by the respective wireless access point continues at processing operation 312.

In processing operation 312, the wireless access point reports its corresponding set of wireless access point parameters/settings/backhaul usage information to the communication management resource 140. This enables the communication management resource to determine which set of the multiple sets of backhaul control settings should be assigned to the corresponding wireless access point.

With further discussion of processing operation 312, it is noted that in processing operation 312 that the respective wireless access point reports a current set of wireless access point parameters to the communication management resource 140 (such as a server). If operation had proceeded to processing operation 312 from processing operation 306, then the reported set of wireless access point parameters is an initial set of wireless access point parameters obtained from the registration process. If execution of the processing operation 312 occurs from processing operation 308, then the wireless access point supplies an updated set of wireless access point parameters to the communication management resource 140. If a timeout occurs in processing operation 310 of the previously discussed countdown timer duration, then the wireless access point reports its corresponding previous parameters or current parameters in processing operation 312 to the communication management resource 140.

Thus, in processing operation 312, the wireless access point reports its corresponding operational parameters/settings and to the communication management resource 140. In one example, in processing operation 312, the wireless access point or other suitable entity then restarts its countdown timer to detect the expiration time duration again.

Subsequent to execution of the processing operation 312, the respective wireless access point executes processing operations 314. In processing operation 314, the respective wireless access point downloads (retrieves from the communication management resource 140) its currently assigned identifier of backhaul control settings (network policy). In other words, the respective wireless access point retrieves an identity value from the communication management resource 140 or other suitable entity. The identity value (such as a group identifier value) indicates the current backhaul control settings (network policy) assigned to it. This currently assigned identifier value may be different than the previous identifier value assigned to the wireless access point.

In processing operation 316, the respective wireless access point executing the flowchart 300 determines whether the identifier indicates a new set of backhaul control settings assigned to the wireless access point. For example, the wireless access point may be initially assigned a first set of backhaul control settings assigned a first identity value (GROUP 1). The identifier as retrieved during processing operation 314 may indicate a second identity value (GROUP 2) as a replacement to the first identity value. In such an instance, the wireless access point knows that its assigned backhaul control settings have changed and that the wireless access point must retrieve the new backhaul control settings assigned the second identity value.

In processing operation 318, in response to detecting a service bubble change in processing operation 316, the respective wireless access point retrieves its newly assigned backhaul control settings from the communication management resource 140. As previously discussed, the respective wireless access point may be assigned a new set of backhaul control settings as indicated by the setting of the flag or assignment of a new identity value (such as grouping or network policy). In such an instance, the wireless access point retrieves and stores the latest backhaul control settings assigned to the wireless access point.

Alternatively, in processing operation 316, the respective wireless access point may learn that there is no change in the identity value assigned to the wireless access point. In such an instance, the wireless access point knows that there is no change to the backhaul control settings currently implemented by the wireless access point. Accordingly, in this case, processing of the respective wireless access point continues at processing operation 325, where the respective wireless access point continues to use the currently downloaded set of backhaul control settings.

Further, in processing operation 327, the respective wireless access point determines whether there is a change to any network policies currently assigned to it. If so, processing continues at processing operation 329, where the wireless access point downloads any new network policies or updated network policies. As previously discussed, the network policies indicate backhaul control settings to be used by the respective wireless access.

Conversely, in processing operation 327, if the wireless access point determines that there are no new network policies or network policy changes available from the communication management resource 140 or other entity, the wireless access point initiates execution of the processing operation 304 again.

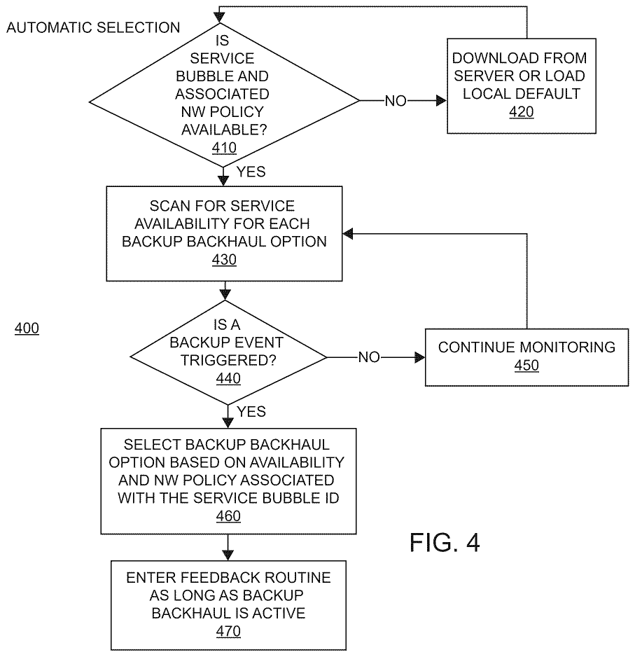

In summary, the respective wireless access point in the network environment 100 performs one or more the following operations:
(306) initial Registration performed?
(308) Have parameters changed?
(310) Periodic countdown timer and corresponding time duration expired?
(312) wireless access point reports Router/Radio node parameters to the server
(314) the respective wireless access point downloads current service bubble ID and network policy
(316) wireless access point checks if service bubble ID (group identifier value) assigned to the wireless access point as changed
(318) the respective wireless access point stores new group identifier value and downloads its assigned network policy of multiple available NW (a.k.a., network) policies
(325) the wireless access point retains service bubble ID if there is no change to the group assignment of the wireless access point
(327) in wireless access point checks if network policies have changed
(329) the wireless access point downloads a new network policy of backhaul control settings assigned to it
(304) the wireless access point monitors Router/Radio node state and usage
FIG. 4 is an example diagram illustrating automatic selection of one or more backhauls by a wireless access point to support wireless and/or wired connectivity between one or more mobile communication devices and a remote network as discussed herein.

In this example, in processing operation 410, the respective wireless access point is configured to determine whether a service identifier and corresponding network policy such as backhaul configuration settings are available for retrieval for use at the wireless access point. If not, in processing operation 420, the wireless access point downloads an appropriate network policy and corresponding set of backhaul control settings from the communication management resource 140 that has been assigned to it or the wireless access point retrieves stored local default backhaul control settings for its use.

Alternatively, in processing operation 410, if the service identifier and/or corresponding network policy such as backhaul control settings assigned to the wireless access point are available at the respective wireless access point for use, in processing operation 430, the respective wireless access point scans the wireless spectrum in the network environment 100 for any available backhauls such as via monitoring channels supported by those backhauls as indicated by the assigned backhaul control settings.

Note that processing operation 430 may include the respective wireless access point transmitting a respective discovery request for each possible backhaul or wireless network and listening for respective responses from corresponding wireless base stations in the network environment 100 for wireless networks providing the corresponding backhaul. At any time, the respective wireless access point can be configured to perform a diagnostic check to determine a respective quality (link quality such as data throughput, data latency, etc.) of backhaul service provided by each of the potentially available backhaul services. Thus, the respective wireless access point can be configured to use one or more of the backhaul services to support conveyance of communications between corresponding one or more mobile communication devices and a remote network.

In further processing operation 440, the respective wireless access point monitors for occurrence of a trigger event such as a condition in which a current one or more backhauls as indicated by the currently assigned backhaul control settings (currently network policy assigned and used by the wireless access point) do not provide the wireless access point sufficient ability to support (above a performance or link quality threshold level) conveyance of respective communications between the communication devices and the remote network through a combination of the respective wireless access point and one or more selected backhauls.

If no trigger event is detected in processing operation 440 such as during a condition in which current use one or more backhauls by the respective wireless access point does provide sufficient data throughput support above a threshold level, processing by the wireless access point continues at processing operation 450, where the respective wireless access point continues to monitor use of or health of the currently available backhauls.

Conversely, if a trigger event such as a performance of a current selected one or more first backhauls falls below a respective one or more threshold levels of providing a sufficient quality of conveyance service in the processing operation 440, the respective wireless access point initiates execution of processing operation 460, where the respective wireless access point switches over to using one or more other backhauls to support conveyance of data between the mobile communication devices and the remote network 190.

In processing operation 470, the respective wireless access point produces feedback indicating a quality of service (such as key performance indicators) associated with use of each of the different backhauls as specified in the network policy of backhaul control settings currently assigned to and used by the wireless access point. In other words, the respective wireless access point can be configured to monitor and generate performance quality associated with each of the available backhauls. As further discussed in flowchart 600, the respective wireless access point can be configured to communicate the detected quality of service associated with each of the different available backhauls (candidate backhauls as indicated by the network policy of backhaul control settings currently assigned to the wireless access point) to the communication management resource 140. Thus, the respective wireless access point can be configured to provide performance (backhaul link quality) feedback associated with each of the backhauls in its currently assigned network policy to the communication management resource 140. This enables the communication management resource 140 to determine whether or not a new set of backhaul configuration settings should be assigned to the wireless access point for use.

In summary, the communication management resource 140 performs one or more of the following operations:
(410) the wireless access point checks if service bubble (group identifier value) and associated NW policy are available
(420) the wireless access point downloads network policy of backhaul control settings from the server or loads default backhaul selection settings
(430) the wireless access point scans for service availability for each backup backhaul option as indicated in the assigned network policy of backhaul control settings
(440) the wireless access point determines if a backup event has been triggered
(450) the wireless access point continues monitoring if no event triggers selection of a backup backhaul option
(460) the wireless access point selects a backup backhaul option based on availability and NW policy associated with the service bubble ID
(470) the wireless access point enters feedback routine as long as backup backhaul is active

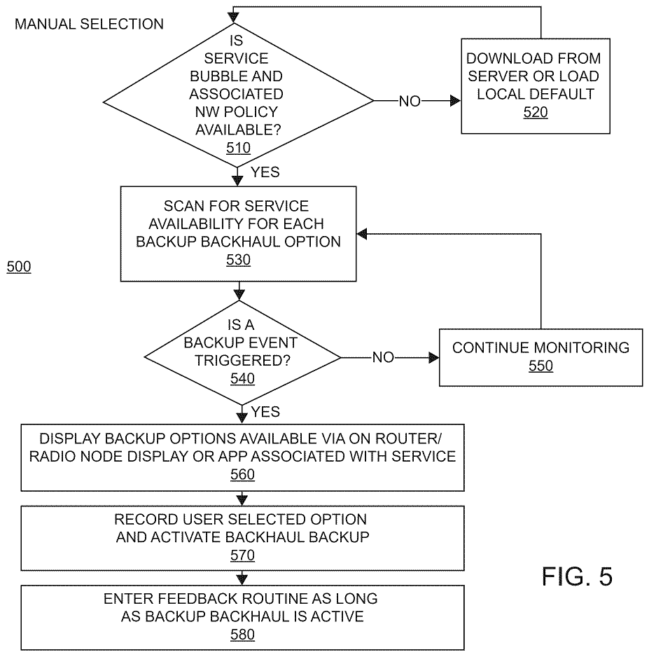

FIG. 5 is an example diagram illustrating manual selection of one or more backhauls by a respective user for use by a wireless access point as discussed herein.

As an alternative to the automatic selection of the one or more backhauls by the respective wireless access point as discussed in the flowchart 400 of FIG. 4, flowchart 500 as discussed in FIG. 5 can be implemented at a respective wireless access point to support manual selection of one or more backhauls.

For example, in processing operation 510 in the flowchart 500 of FIG. 5, the respective wireless access point can be configured to determine whether a service identifier (group identifier value) and corresponding network policy of backhaul configuration settings are already available for implementation by the respective wireless access point. If not, in processing operation 520, the wireless access point downloads an appropriate set of backhaul control settings from the communication management resource 140 that has been assigned to it or the wireless access point uses previously stored local default backhaul control settings.

Alternatively, in processing operation 510, if the service identifier and corresponding network policy such as backhaul control settings assigned to the wireless access point are currently available at the respective wireless access point because they were already retrieved or downloaded, in next executed processing operation 530, the wireless access point scans the wireless spectrum in the network environment 100 for any available backhauls such as via monitoring channels supported by those backhauls as indicated by the assigned backhaul control settings. Note that the monitoring may include the respective wireless access point transmitting a respective discovery request for each possible backhaul or wireless network (as indicated by the corresponding assigned network policy and backhaul control settings) and listening for respective responses from corresponding wireless base stations or wireless networks providing the corresponding backhaul as specified by the backhaul control settings assigned to it.

As a more specific example, the respective wireless access point may be assigned access configuration settings indicating to that the respective wireless access point may use backhaul #2, backhaul #1, backhaul #4, etc.

The wireless access point can be configured to perform a diagnostic check to determine a respective quality of service provided by each of the potentially available backhaul services such as backhaul #2, backhaul #1, backhaul #4, etc. The wireless access point uses one or more of these backhaul services backhaul #2, backhaul #1, backhaul #4, etc., to support conveyance of communications between corresponding one or more mobile communication devices and a remote network 190. In one example, the network policy indicates a respective ranking of backhaul services, where the backhaul #2 is highest ranked in the list, backhaul #1 is second-highest ranked in the list, backhaul #4 is third highest ranked in the list, etc.

In processing operation 540, the wireless access point monitors for occurrence of a trigger event such as a condition in which a current one or more backhauls as indicated by the currently assigned backhaul control settings do not provide the wireless access point sufficient ability to support (above a threshold level) conveyance of respective communications between the communication devices in the remote network through a combination of the wireless access point and one or more selected backhauls.

If no trigger event is detected in processing operation 540 such as during a condition in which currently used one or more backhauls provides sufficient support above a threshold level for the wireless access point to provide a corresponding set of one or more mobile communication devices access to a remote network 190, processing continues at processing operation 550 where the respective wireless access point continues to monitor use of the currently available backhauls as indicated by its current network policy such as ranking of backhaul #2, backhaul #1, backhaul #4, etc.

If a trigger event (such as backhaul performance below a respective threshold level) is detected by the respective wireless access point or other suitable entity in processing operation 540, processing flow of the flowchart 500 continues at processing operation 560.

In processing operation 560, the wireless access point initiates display of the different available backup backhaul options (as indicated by the currently assigned backhaul control settings such as backhaul options backhaul #2, backhaul #1, backhaul #4, etc.) to each of the respective users operating the mobile communication devices wirelessly connected to the wireless access point.

In processing operation 570, the users associated with the mobile communication devices perform a selection and then transmit those selections of respective backhaul options such as selected one or more backhaul options backhaul #2, backhaul #1, backhaul #4, etc., to the respective wireless access point. The users may select the same or different backup backhaul options.

In processing operation 580, the respective wireless access point provides backhaul link quality feedback information to the communication management resource 140 as long as the backup backhaul is used by the wireless access point to support the conveyance of data between mobile communication devices and the remote network 190. The continued feedback of backhaul link quality information enables the communication management resource 140 to potentially modify or update currently assigned backhaul configuration settings used by the respective wireless access point or assign the wireless access point new backhaul control settings.

In summary, the communication management resource 140 performs one or more the following operations:
(510) the wireless access point checks if service bubble and associated NW policy are available to the wireless access point
(520) the wireless access point downloads the network policy of backhaul control settings from the server or loads a default network policy backhaul control settings
(530) the wireless access point scans for service availability for each backup backhaul option as indicated in the assigned network policy of backhaul control settings
(540) the wireless access point determines if a backup event triggered
(550) the wireless access point continues monitoring if no event triggered
(560) the wireless access point initiates display of backup options available via on Router/radio node display or app associated with service
(570) the wireless access point records user selected option and activates backhaul backup options is needed
(580) the wireless access point enters feedback routine as long as backup backhaul is active

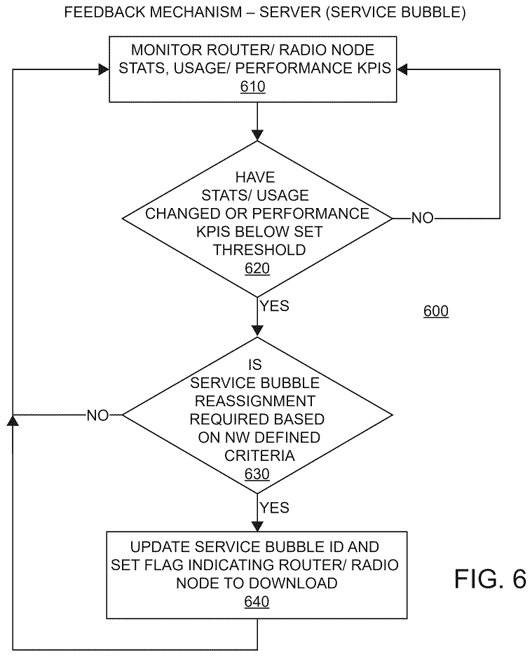

FIG. 6 is an example diagram illustrating operations associated with a communication management resource updating backhaul configuration settings based on feedback from one or more wireless access points as discussed herein.

In this example, the flowchart 600 supports a feedback mechanism associated with communication management resource 140.

For example, in processing operation 610, the communication management resource 140 monitors each of the wireless access points for backhaul usage information (such as an amount of data conveyed by a respective wireless access point over a selected backhaul over time), backhaul performance quality such as KPIs (Key Performance Indicators) indicating ability to support conveyance of backhaul data over respective backhauls, etc. This processing operation 610 may include the communication management resource 140 receiving feedback from each of the multiple wireless access points in the network environment 100. Thus, for each grouping of wireless access points assigned a respective network policy of backhaul control settings, the communication management resource 140 receives the feedback from each of the different wireless access points in a grouping indicating performance associated with those identified backhauls in the assigned network policy for that grouping.

In processing operation 620, the communication management resource 140 analyzes the feedback of backhaul usage information for any changes as well as whether any instances of backhaul link quality performance as indicated by the feedback falls below a respective threshold. If not, the communication management resource 140 continues to execute the processing operation 610 again.

Conversely, if the communication management resource 140 detects that there is a change in usage of the backhaul links or performance associated with any of the backhaul links or a collective performance of the backhaul links associated with a respective backhaul network policy falls below a respective threshold level, processing by the communication management resource 140 continues at processing operation 630.

In processing operation 630, the communication management resource 140 determines whether there is a need to assign a new set of backhaul control settings to any of the wireless access points or groupings of wireless access points based upon network defined criteria (network policy input 206 or input 105) such as indicating a minimum connection quality (such as minimum data throughput threshold level of data over each backhaul, latency threshold level associated with communicating data over each backhaul, etc.) required to be provided to the mobile communication devices communicating through each wireless access points included in a group to the remote network 190.

If the determination by the communication management resource 140 in processing operation 630 indicates that the respective currently assigned network policy of backhaul control settings do provide sufficient link quality with respect to the minimum connection quality is indicated by the network policy input 206 or network policy input 105 (information indicating criteria of services to be provided to the wireless access point), then processing by the communication management resource 140 continues at processing operation 610 again. Conversely, if the determination in processing operation 630 indicates that the respective currently assigned network policy of backhaul control settings for a particular grouping does not provide sufficient link quality with respect to the minimum connection quality as indicated by the defined criteria (such as specified by the network policy input 206 or policy input 105 or other permission), then processing by the communication management resource 140 continues at processing operation 640.

In processing operation 640, the communication management resource 140 updates the corresponding network policy identifier (group identifier) and corresponding backhaul configuration settings assigned to the wireless access point that currently is not provided sufficient backhaul performance with its current network policy of backhaul control settings. This may include the communication management resource 140 setting a flag to indicate that new configuration settings are available as well as indicate an identity of a new backhaul service policy (network policy or group identifier value) to be used by the respective wireless access point. The flag notifies the respective wireless access point of a need to download the new network policy as indicated by the new service bubble identifier (grouping) assigned to the wireless access point.

In summary, the communication management resource 140 performs one or more the following operations:
(610) the communication management resource 140 monitors router/radio node stats, usage/performance KPIs (users and backhaul link quality)
(620) the communication management resource 140 detects whether Stats/backhaul usage changed OR performance KPIs associated backhauls is below set threshold
(630) the communication management resource 140 determines if the Service bubble reassignment is required based on NW defined criteria
(640) the communication management resource 140 updates service bubble ID and set flag indicating router/radio node to download

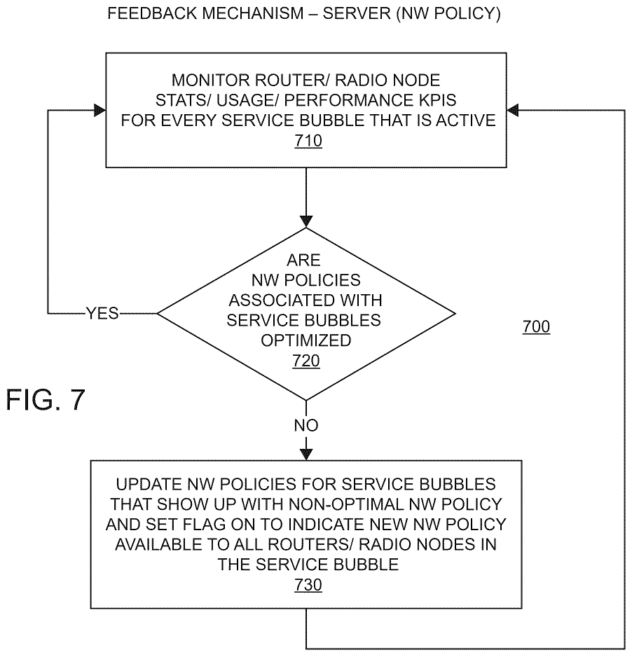

FIG. 7 is an example diagram illustrating updating of one or more network policies (backhaul configuration settings) based on feedback from one or more wireless access points as discussed herein.

In this example, flowchart 700 illustrates operations associated with the communication management resource 140 receiving backhaul link quality feedback and then updating respective one or more network policies such as backhaul control settings for different groupings of wireless access points.

For example, in processing operation 710, as previously discussed, the communication management resource 140 monitors the corresponding backhaul link quality provided by each of the different backhauls in the network environment 100 as indicated by the assigned network policy of backhaul control settings. Further, as previously discussed, one way that the communication management resource 140 learns of the backhaul link quality for each backhaul is receipt of the feedback provided by each of different wireless access points using those backhauls. In other words, as previously discussed, each of the wireless access points in a particular grouping uses the backhauls and then provides feedback associated with each of the available backhauls to the communication management resource 140. Thus, in one example, the communication management resource 140 may receive feedback from multiple wireless access points using the same or different assigned backhaul control settings.

Based upon the feedback from the wireless access points in a particular grouping or multiple different groupings, the communication management resource 140 determines which of the backhauls performs poorly such as below a minimal link quality threshold level and which of the backhauls performs above a minimum required backhaul link quality minimal threshold level.

Further, in processing operation 720, the communication management resource 140 determines whether the network policies (i.e., backhaul control settings assigned to the different groupings of wireless access points) are optimized or not. If the communication management resource 140 determines that the network policies of backhaul configuration settings are optimized such as that a set of corresponding backhauls included in a respective network policy of backhaul control settings are above a link quality threshold level, the communication management resource 140 continues in processing operation 710 without changing the current respective network policy because there is no need to do so.

Alternatively, if the communication management resource 140 determines that the network policies assigned use of the different backhauls is not optimized such as that the backhauls indicated in a respective network policy do not provide appropriate backhaul support, then processing continues at processing operation 730 where the communication management resource modifies or updates the backhaul network policies.

For example, in processing operation 730, the communication management resource 140 updates the network policies for each of the different service groupings that indicate a non-optimal network policy. This may include updating a current network policy into an updated network policy assigned to a respective wireless access point grouping or creating a completely new network policy assigned to a particular wireless access point grouping.

Subsequent to updating the network policy (backhaul control settings) assigned to the particular wireless access point grouping, the communication management resource 140 sets a corresponding flag associated with each of the wireless access points in the particular wireless access point grouping to indicate that those wireless access points are now assigned a new network policy (backhaul control settings). In such an instance, as previously discussed, when those wireless access points in the particular wireless access point grouping detect that their flag is set (indicating a new network policy of backhaul control settings), each of those wireless access points in particular wireless access point grouping retrieves the newly generated or newly updated network policy (backhaul control settings) and implements those new backhaul control settings when providing connectivity between respective mobile communication devices and the remote network 190.

As further shown in flowchart 700, after completing processing operation 730, execution flow associated with the communication management resource 140 continues at processing operation 710.

Accordingly, the communication management resource 140 can be configured to continually update the network policy of wireless backhaul control settings assigned to a particular wireless access point group based on monitoring link quality performance provided by those backhauls as indicated by feedback from the wireless access points in the particular wireless access point group.

In summary, the communication management resource performs one or more the following operations:
(710) the communication management resource 140 monitors wireless access point/router/radio node stats/usage/performance KPIs for every service bubble that is active
(720) the communication management resource 140 determines if NW policies associated with service bubbles are optimized
(730) the communication is resource 140 updates NW policies for service bubbles that show up with non-optimal NW policy and set flag on to indicate new NW policy available to all routers/radio nodes in the service bubble

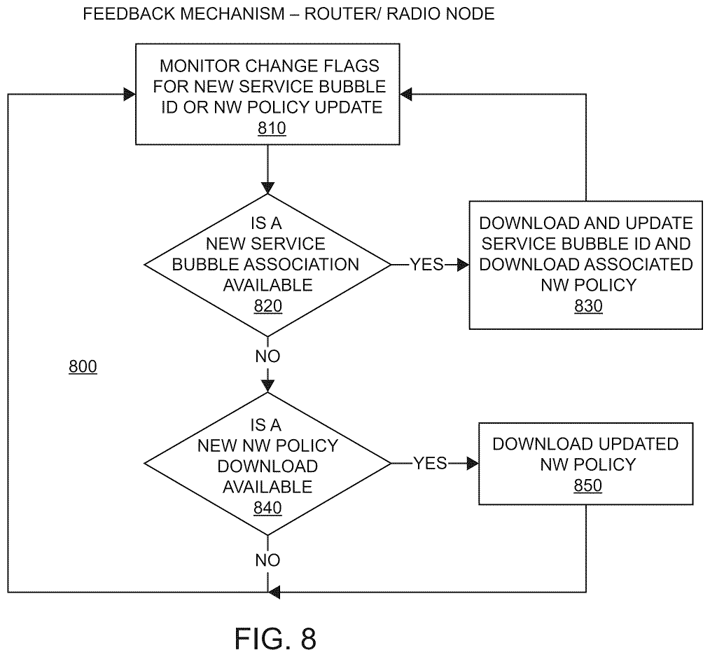

FIG. 8 is an example diagram illustrating a wireless access point monitoring availability of updated access configuration settings as discussed herein.

In this example, as previously discussed, a respective wireless access point in the network environment 100 is configured to occasionally check with the communication management resource 140 regarding whether or not the wireless access point has been assigned a new or updated network policy of backhaul control settings for use by the corresponding wireless access point.

More specifically, in processing operation 810, the corresponding wireless access point monitors a change in flag setting associated with the corresponding wireless access point as maintained by the communication management resource 140. As previously discussed, the setting of the flag assigned to the respective wireless access point may indicate that the respective wireless access point is assigned a new grouping and therefore a corresponding new policy of backhaul control settings for retrieval and implementation by the respective wireless access point. Alternatively, the network policy associated with the wireless access point grouping to which the corresponding wireless access point currently belongs may be updated to include an updated network policy of backhaul control settings. For example in this latter case, the first network policy may be assigned to the wireless access point grouping and corresponding members of wireless access points in that grouping. Based on the feedback the first network policy may be updated into an updated first network policy. In such an instance, when each respective wireless access point in the group is assigned a new or updated, the wireless access points in the group are notified to implement the updated first network policy as a replacement to the original first network policy of backhaul control settings.

In processing operation 820, via the flag information maintained by the communication management resource 140 for each respective corresponding wireless access point, each respective wireless access point is notified whether or not the respective wireless access point is assigned a new network policy associated with a different wireless access point grouping. If so, in processing operation 830, the wireless access point downloads or retrieves its updated wireless access point group identity value and corresponding network policy associated with that wireless access point grouping. The corresponding wireless access point then implements the new network policy associated with the new wireless access point group identity value (service level identifier). Subsequent to processing operation 830, the corresponding wireless access point executes processing operation 810 again.

Alternatively, if the flag information associated with the corresponding wireless access point as maintained by the communication management resource 140 in processing operation 820 does not indicate that a new group identity is assigned to the corresponding wireless access point, the respective wireless access point executes the processing operation 840.

In processing operation 840, the respective wireless access point determines whether a new policy of backhaul control settings or an updated policy of backhaul control settings associated with the current wireless access point group assignment is available. If not, the corresponding wireless access point continues with execution of processing operation 810 using the old assigned network policy of backhaul control settings. Alternatively, if a new policy associated with the corresponding wireless access point and currently assigned wireless access point grouping is available, the corresponding wireless access point initiates execution of the processing operation 850 2 retrieve the new network policy of backhaul control settings.

In processing operation 850, the respective wireless access point communicates with the communication management resource 140 to retrieve the new policy of backhaul control settings to support conveyance of communications between multiple mobile communication devices and the remote network over a combination of the respective wireless access point and the one or more available backhauls as indicated by the new policy.

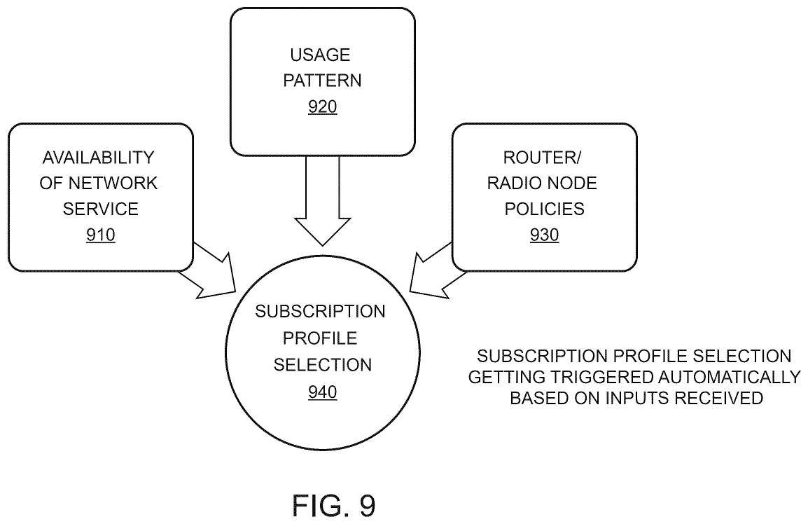

Thus, in summary, each respective wireless access as discussed herein can be configured to perform one or more of the following operations:
7.1. Monitor change flags for new service bubble ID or NW policy update
7.2. Is a new service bubble association available?
7.3. Download and update service bubble ID and download associated NW policy
7.4. Is a new NW policy download available?
7.5. Download updated NW policy
FIG. 9 is an example diagram illustrating subscription profile selection being triggered automatically based on received inputs as discussed herein.

In this example, a combination of input 910 such as availability of network services, input 920 such as wireless usage patterns, and input 930 such as wireless access point policies, is used as a basis in which to produce respective subscription profile selection information 940.

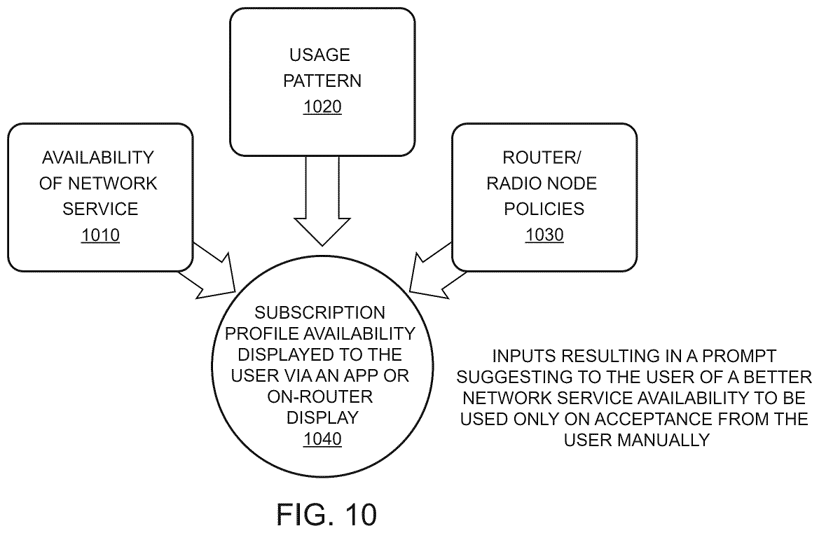

FIG. 10 is an example diagram illustrating inputs resulting in the prompt suggesting of suggesting better use of the network to a user as discussed herein.

In this example, a combination of input 1010 such as availability of network services, input 1020 such as wireless access point usage patterns, input 1030 such as wireless access point network policies, is used as a basis in which to produce respective subscription profile availability information displayed to a user as discussed herein.

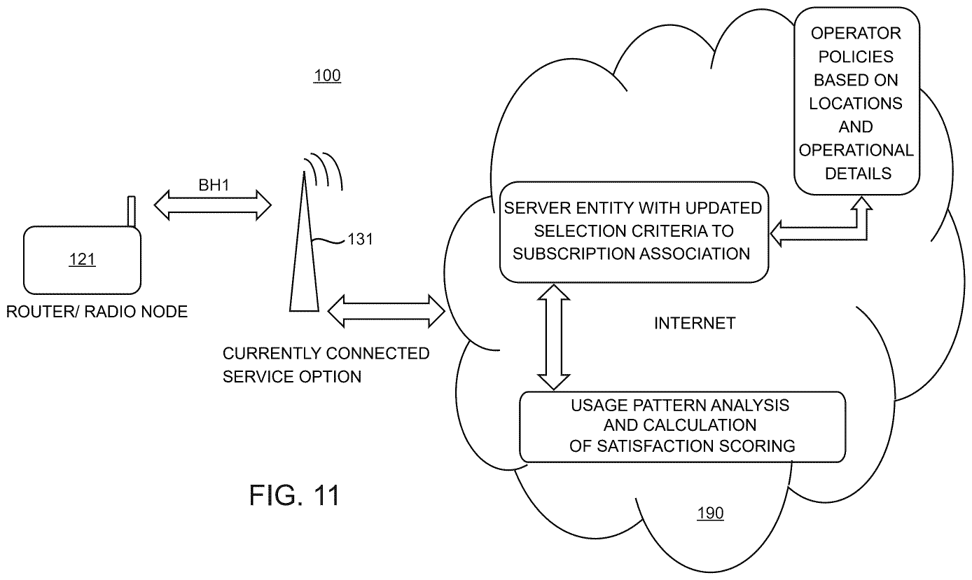

FIG. 11 is an example diagram illustrating implementation of a network environment corresponding operations as discussed herein.

In this example, the wireless access point 121 implements the backhaul BH1 to wirelessly connect to the wireless base station 131, which is in turn in communication with the network 190, providing services as discussed herein.

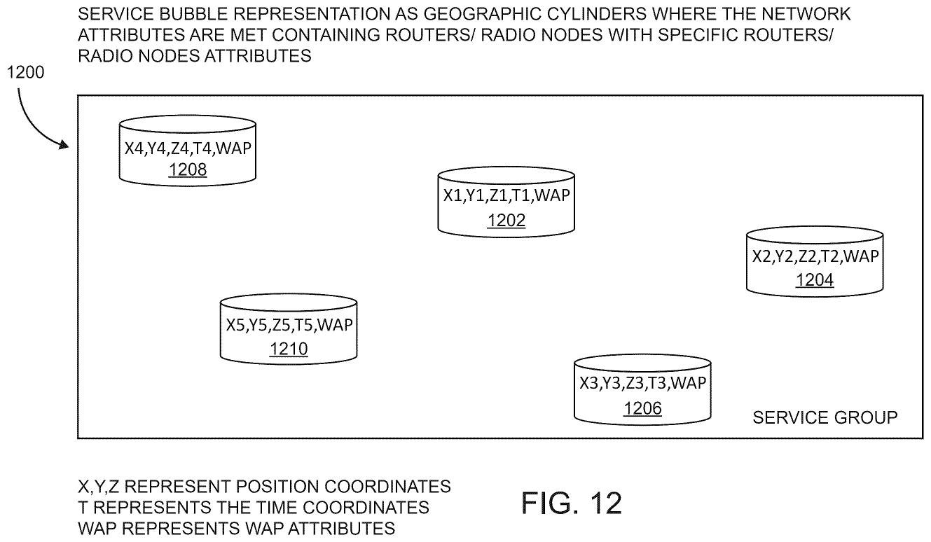

FIG. 12 is an example diagram illustrating a service bubble representation and storage of a respective information as discussed herein.

In this example, service bubble representation 1200 includes five different data sets (1202, 1204, 1206, 1208, 1210) corresponding to different selection criteria and subscriptions. X, Y, Z represents position coordinates of the wireless access points, value WAP represents wireless access point attributes, and N represents network attributes.

FIG. 13 is an example diagram illustrating management of backhaul usage amongst multiple wireless access points as discussed herein.

As previously discussed, the network environment 100 includes wireless access point 121 providing a group of mobile communication devices including mobile communication device 111, mobile communication device 112, etc., access to the remote network 190 and corresponding communication devices 196 (such as the network 190) via selection and use of one or more backhauls sign for its use as indicated by a current network policy assigned by the communication management resource 140 2 the wireless access point 121.

Initially, as previously discussed, the communication management resource 140 receives parameter information (such as a configuration, subscription information, etc.) associated with the wireless access point 121. The communication management resource 140 can be configured to receive the parameter/configuration settings assigned to the wireless access point 121 during the registration of the wireless access point 121 with the communication management resource 140.

Additionally, as previously discussed, the communication management resource 140 receives network policy input 105 (network criteria indicating different levels of service provided to the different wireless access points) from a corresponding network service provider associated with the communication management resource 140. Based on the network policy input 105 indicating different services and different service levels (such as minimum amount of data throughput to be supported over respective backhauls between the wireless access point and the remote network 190) to provide different classes of wireless access points, the communication management resource 140 assigns each of the wireless access points in the network environment 100 a corresponding group ID value (group identity value) such as GROUP1, GROUP 2, GROUP 3, etc.

Thus, as previously discussed, the different wireless access points in the network environment 100 are assigned a different group identifier value depending upon what minimum threshold level of services are to be provided to those wireless access points in a corresponding group.

In this example, assume that the communication management resource 140 determines that both wireless access point 121 and wireless access point 122 are to be assigned the group identifier GROUP1 because they both must be provided a particular level of backhaul services that happened to be supported by the network policy NWP1 of backhaul control settings.

In addition to assigning each wireless access point in the network environment 100 a corresponding group identifier value depending upon the backhaul services to be provided to the respective wireless access point, the communication management resource 140 produces a respective network policy for each of the different backhaul service class groupings.

For example, in accordance with the network policy input 105, the communication management resource 140 produces the different service classes such as GROUP 1, GROUP 2, etc.

Based on subscription information or configuration settings or other information associated with each of the wireless access point, the communication management resource 140 assigns the wireless access points in the network environment 100 to a particular group. More specifically, via the communication management resource 140 or other suitable entity, a first set of wireless access points in the network environment 100 are assigned the group identifier value GROUP 1 and corresponding network policy NWP#1 of backhaul control settings; a second group of wireless access points in the network environment 100 are assigned the group identifier value GROUP2 and corresponding network policy NWP#2 of backhaul control settings; a third group of wireless access points in the network environment 100 are assigned the group identifier value GROUP 3 and corresponding network policy NWP #3 of backhaul control settings; and so on.

In this example, assume that the communication management resource 140 assigns the wireless access point 121 the group identifier value GROUP1 at or around time T1 based on the configuration settings associated with the wireless access at 121 and/or subscription information associated with the wireless access point 121. The subscription information can be configured to indicate which of the different backhauls the wireless access point 121 subscribes. In other words, the subscription information can indicate that the wireless access point 121 has a subscription and/or corresponding signed SIM credentials to use the backhaul BH1; the subscription information can indicate that the wireless access point 121 has a subscription and/or corresponding signed SIM credentials to use the backhaul BH2; the subscription information can indicate that the wireless access point 121 has a subscription and/or corresponding signed SIM credentials to use the backhaul BH3; and so on.

In one example, because the wireless access point 121 has a subscription supporting each of the backhauls BH1, BH2, BH3, BHP, the communication management resource 140 may assign the network policy NWP1 to the wireless access point 121. As previously discussed, assignment of a respective network policy of backhaul control settings to the wireless access point 121 may include setting a respective flag indicating such a condition.

The wireless access point 121 can be configured to poll the communication management resource 140 for the availability of its assigned backhaul control settings. Alternatively, the communication management resource 140 can be configured to push the backhaul control settings assigned to the wireless access point 121 over the network 190 and any suitable communication link to the wireless access point 121.

Either way, the communication management resource 140 distributes first access configuration settings (such as network policy NWP #1) to the wireless access point 121.

The first access configuration settings (such as network policy NWP#1 of backhaul control settings) are generated to control selection, by the wireless access point 121, of at least one backhaul amongst multiple backhauls available for use by the first wireless access point in order to support communications between the multiple mobile communication devices including mobile communication device 111, mobile communication device 112, etc., through the wireless access point 121 and at least one backhaul to the network 190 and corresponding communication devices 196.

For example, as shown in FIG. 13, the received network policy NWP1 assigned to the wireless access point 121 can be configured to indicate a priority ranking 191 of the backhaul BH2 as a highest ranking backhaul for use by the wireless access point 121; the network policy NWP1 assigned to the wireless access point 121 can be configured to indicate a priority ranking 191 of the backhaul BH1 as a next highest ranking backhaul for use by the wireless access point 121; the network policy NWP1 assigned to the wireless access point 121 can be configured to indicate a priority ranking 191 of the backhaul BH3 as a next highest ranking backhaul for use by the wireless access point 121; and so on. Thus the ranking 191 can indicate the highest priority backhaul as being backhaul BH2, the next highest priority backhaul as being BH1, and so on.

In such an instance, the wireless access point 121 first attempts to use the backhaul BH2 to provide connectivity between the mobile communication devices and the remote network 190 is the backhaul BH2 is available.

If the backhaul BH2 is determined by the wireless access point 121 to be unavailable, the wireless access point 121 attempts to use the backhaul BH1 to provide connectivity between the mobile communication devices and the remote network 190.

If the backhaul BH1 is determined to be unavailable, the wireless access point 121 attempts to use the backhaul BH3 to provide connectivity between the mobile communication devices and the remote network 190.

It is further noted that the backhaul BH1 can be configured to include multiple portions such as a first portion backhaul BH1-1 (such as including a wireless communication link) between the wireless access point 121 and the wireless base station 131. The backhaul BH1 also includes a second portion backhaul BH1-2 (such as wired or wireless communication link) between the wireless base station 131 and the remote network 190.

It is further noted that the backhaul BH2 can be configured to include multiple portions such as a first portion backhaul BH2-1 (such as wireless communication link) between the wireless access point 121 and the wireless base station 132. The backhaul BH2 also includes a second portion backhaul BH2-2 (such as wired or wireless communication link) between the wireless base station 132 and the remote network 190.

It is further noted that the backhaul BH3 can be configured to include multiple portions such as a first portion backhaul BH3-1 (such as wireless communication link) between the wireless access point 121 and the wireless base station 133. The backhaul BH3 also includes a second portion backhaul BH3-2 (such as wired or wireless communication link) between the wireless base station 133 and the remote network 190.

It is further noted that the wireless access point 121 may include a respective physical communication link such as backhaul BHP enabling the wireless access point 121 to support communications with the remote network 190. In this example, the network policy NWP1 indicates the availability of the backhaul BHP as an option to communicate with the remote network 190.

While providing the connectivity between the set of mobile communication devices including 111, 112, etc., and the network 190, the wireless access point 121 generates feedback indicating a respective link quality associated with each of the backhauls as specified by the network policy NWP #1. In such an instance, the communication management resource 140 receives first feedback from the first wireless access point 121 indicating a performance of the backhaul BH1; the communication management resource 140 receives second feedback from the first wireless access point 121 indicating a performance of the backhaul BH2; the communication management resource 140 receives third feedback from the first wireless access point 121 indicating a performance of the backhaul BH3; and so on. Accordingly, the communication management resource 140 is aware of the different link quality associated with each backhaul.

The first feedback from the wireless access point 121 may be generated by the wireless access point 121 based on the first wireless access point 121 providing multiple mobile communication devices (111, 112, etc.) access to a remote network 190 via the first access configuration settings NWP1 or a specific backhaul of the network policy NWP1.

The feedback generated by the wireless access point 121 or other suitable entity can be configured to indicate any suitable information. In one example, the feedback supplied by the wireless access point 121 to the communication management resource 140 indicates a link quality performance of each of the backhauls providing the wireless access point 121 connectivity using one or more of the backhauls as specified by the assigned network policy NWP1.

In another example, the feedback from the wireless access point 121 may indicate a change in use of one or more selected backhauls by the first wireless access point 121 to support conveyance of communications associated with the multiple mobile communication devices. In other words, the wireless access point 121 may initially implement the network policy NWP1 and corresponding backhaul BH2 to support communications between the wireless access point 121 in the remote network 190. This backhaul BH2 may no longer provide good connectivity over time. The feedback such as a change in the use of the backhauls to the communication management resource 140 provides notification of the potential degradation associated with backhaul BH2. This degradation may result in the communication management resource 140 updating a network policy assigned to the wireless access point 121.

In another example, the feedback from the wireless access point 121 indicates a change in performance of one or more the backhauls over time.

The communication management resource 140 analyzes the feedback to determine if the assigned backhaul control settings NWP1 provides the wireless access point 121 sufficient bandwidth to convey communications between the wireless access point and a remote network 190 on behalf of mobile communication devices 111, 112, etc.

For example, as previously discussed, the network policy input 105 can be configured to indicate a certain level of service quality to provide to the different wireless access points and different sets of communication devices as present in the network environment 100. The communication management resource 140 may determine from the feedback that wireless access point 121 does not provide a corresponding set of mobile communication devices (111, 112, etc.) and corresponding wireless access point 121 in the subscriber domain 151 sufficiently good access through the wireless access point 121 to the network 190. In such an instance, the communication management resource 140 can be configured to reassign the wireless access point 121 to a different group identifier value GROUP2 and corresponding network policy NWP2 for use by the wireless access point 121 because the group identifier value GROUP2 and corresponding network policy NWP2 are known to provide the backhaul quality assigned to the wireless access point 121.

It is noted further that the feedback can be configured to indicate a data throughput performance associated with each backhaul selected for use by the first wireless access point 121. The second access configuration settings (such as network policy NWP2) can be assigned to the first wireless access point 121 as the replacement based on the data throughput performance of one or more of the backhauls as indicated by the network policy NWP1 being less than a threshold level.

Thus, in one example, based on the feedback received from the wireless access point 121 or other suitable entity to the network environment 100, the communication management resource 140 can be configured to assign second access configuration settings such as network policy NWP2 to the wireless access point 121 at or around time T2 in order to ensure that the minimum backhaul link quality level is provided to the wireless access point 121. The network policy NWP2 (second access configuration settings) serves as a replacement to the first access configuration settings (NWP1).

The communication management resource 140 distributes the updated or replacement access configuration settings such as network policy NWP2 to the wireless access point 121. This distribution of the network policy NWP2 and the corresponding backhoe control settings ensures that the wireless access point 121 and corresponding mobile communication devices 11, 112, etc., are provided the appropriate wireless services.

As previously discussed, each of the different network policy may indicate a different ranking of desired use associated with the different backhauls. For example, the first access configuration settings such as network policy NWP1 can be configured to indicate a first ranking 191 (BH2, BH1, BH3, BHP) of the multiple backhauls. The second access configuration settings (BH3, BH1, BH2, BHP) such as network policy NWP2 can be configured to indicate a second ranking of the multiple backhauls, where the second ranking 192 is different than the first ranking 191.

Accordingly, the communication management resource 140 can be configured to control use of the different backhauls by the different sets of wireless access points. More specifically, the communication management resource 140 generates the first network policy of backhaul control settings to control use of a first set of backhauls by a first set of wireless access points assigned to the first network policy NWP1; the communication management resource 140 generates the second network policy NWP2 of backhaul control settings to control use of a second set of backhauls by a second set of wireless access points assigned to the second network policy; and so on.

Thus, in one example, such as during registration, the wireless access point 121 transmits communications 1305 to the communication management resource 140. The communications 1305 indicate an identity of the wireless access point 121 as well as any other suitable information such as its configuration settings and/or subscription settings. Accordingly, based upon the information associated with the wireless access point 121, the communications 1305 enable the communication management resource 140 to determine a corresponding network policy to assign to the wireless access point 121. In this example, assume that the communication management resource 140 determines that the wireless access point 121 should be assigned the identifier value GROUP1 and corresponding network policy NWP1.

In subsequent processing operation #1, via communications 1310, the communication management resource 140 or other suitable entity provides notification of assignment of the network policy NWP1 of backhaul control settings to the wireless access point 121. Note that communications 1310 may include distribution of the network policy NWP1 from the communication management resource 140 to the wireless access point 121. The wireless access point 121 stores the network policy NWP1 of backhaul control settings.

In processing operation #2, at or around time T1, the wireless access point 121 implements the backhaul control settings as indicated by the network policy NWP1. As previously discussed, the wireless access point 121 can be configured to monitor the network environment 100 for wireless channels sporting the different backhaul options as indicated in the network policy NWP1.

In processing operation #3, the wireless access point 121 provides feedback as previously discussed in communications 1320 to the communication management resource 140, where the feedback indicates any suitable information such as a quality or simply availability of service (such as data throughput rate, data latency rate, etc.) associated with use of each of the different backhauls BH1, BH2, BH3.

In processing operation #4, in response to receiving the feedback from each of the wireless access points or feedback from the wireless access point 121, the communication management resource 140 either updates the network policy NWP1 to a new version of network policy NWP1-1 or assigns the wireless access point 121 to the GROUP2 and corresponding network policy NWP2. Either of these network policies will provide the wireless access point 121 sufficient backhaul link quality as is required by its subscription. In this example, in processing operation #4, assume that the communication management resource 140 updates the original network policy NWP1 assigned to the service class GROUP1 into the network policy NWP1-1.

In processing operation #5, via communications 1330, the communication management resource 140 notifies the wireless access point 121 of the update of the network policy NWP1 to network policy NWP1-1 in order to provide the wireless access point 121 the appropriate service to which the wireless access point 121 is entitled as indicated by the network policy input 105. Alternatively, as previously discussed in FIG. 1, the communication management resource 140 can be configured to reassign the wireless access point 121 the service class identifier GROUP2 as a replacement to GROUP1. In such an instance, via communications 1330, the communication management resource 140 with transmit the network policy NWP2 to the wireless access point 121 as a replacement to the network policy NWP1 in order to provide the wireless access point 121 the appropriate backhaul services specified by the network policy input 105.

Accordingly, note that the wireless access point 121 implements either network policy NWP2 or the network policy NWP1-1 depending upon whether the communication management resource 140 changed the group identifier assigned to the wireless access point 121.

In processing operation #6, the communication management resource 140 transmits the new network policy NWP1-1 or the network policy NWP2 to the wireless access point 121.

In processing operation #7, the wireless access point 121 the wireless access point 121 implements the network policy NWP1-1 (if the same group ID group #1 is assigned) by selecting one or more of the backhauls in accordance with the assigned network policy to provide connectivity between the wireless access point 121 and the remote network 190, where the newly selected backhauls support conveyance of data communications between the mobile communication devices 111, 112, etc., in the communication devices 196 through a combination of the wireless access at 121, backhauls, and remote network 190.

Alternatively, in processing operation #7, if the group ID changed, the wireless access point 121 implements the new network policy NWP2 (if a new group ID group #2 is assigned) by selecting one or more of the backhauls in accordance with the assigned network policy to provide connectivity between the wireless access point 121 and the remote network 190, where the newly selected backhauls support conveyance of data communications between the mobile communication devices 111, 112, etc., in the communication devices 196 through a combination of the wireless access at 121, backhauls, and remote network 190.

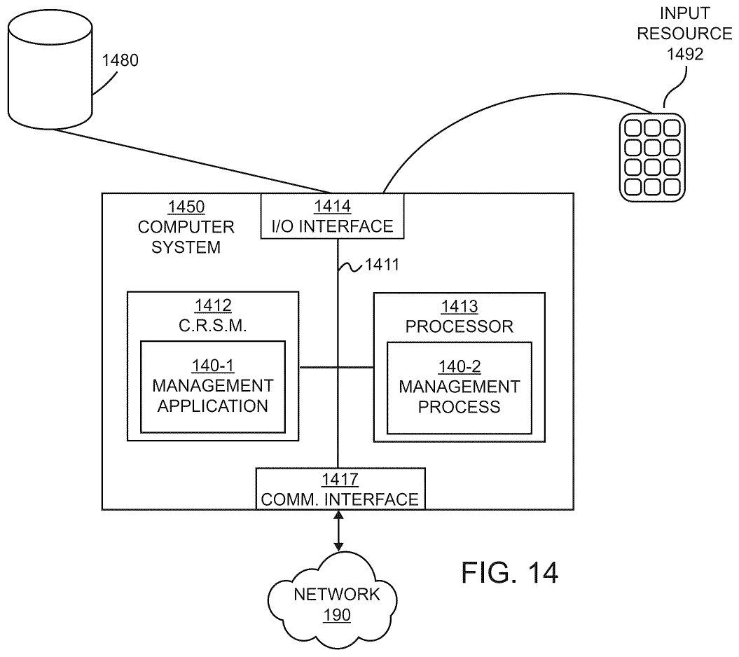

FIG. 14 is an example block diagram of a computer system for implementing any of the operations as previously discussed according to examples herein.

Any of the resources (communication device 111, communication device 112, wireless access point 121, wireless access point 122, communication management resource 140, etc.) as discussed herein can be configured to include computer processor hardware and/or corresponding executable instructions to carry out the different operations as discussed herein via computer system 1450.

As shown, computer system 1450 of the present example includes an interconnect 1411 coupling computer readable storage media 1412 such as a non-transitory type of media or, more generally, computer readable hardware which can be any suitable type of hardware storage medium in which digital information can be stored and retrieved, a processor 1413 (computer processor hardware), I/O interface 1414, and a communications interface 1417.

I/O interface(s) 1414 supports connectivity to repository 1480 and input resource 1492.

Computer readable storage medium 1412 (such as computer readable hardware or other suitable entity) can be a hardware storage device or resource such as memory, optical storage, hard drive, floppy disk, etc. In one example, the computer readable storage medium 1412 stores instructions and/or data. Computer readable storage medium 1412 can be a non-transitory storage medium or include non-transitory storage hardware.

As shown, computer readable storage media 1412 can be encoded with communication management application 140-1 (e.g., including instructions) to carry out any of the operations as discussed herein.

During operation of one example, processor 1413 accesses computer readable storage media 1412 via the use of interconnect 1411 in order to launch, run, execute, interpret or otherwise perform the instructions in management application 140-1 stored on computer readable storage medium 1412. Execution of the management application 140-1 produces the management process 140-2 to carry out any of the operations and/or processes as discussed herein.

Those skilled in the art will understand that the computer system 1450 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, wireless station, connection management resource, a wireless device, a wireless access point, a access point, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1450 may reside at any location or can be included in any suitable resource in any network environment to implement functionality as discussed herein. In one example, the control system 1450 can include or be implemented in virtualization environments such as the cloud.

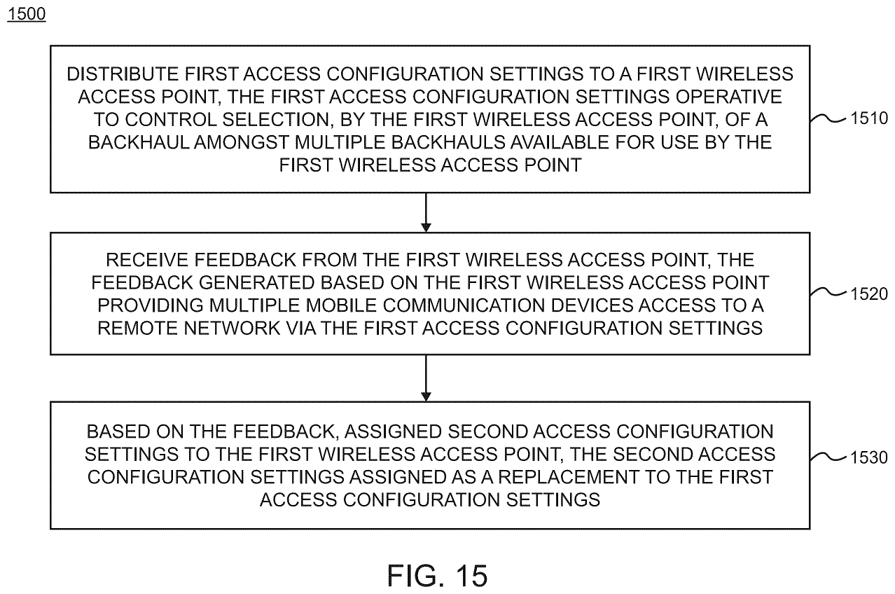

Functionality supported by the different resources will now be discussed via flowchart in FIG. 15. Note that the steps in the flowcharts below can be executed in any suitable order.

FIG. 15 is a flowchart 1500 illustrating an example method according to examples. Note that flowchart 1500 overlaps/captures general concepts as discussed herein.

In processing operation 1510, the communication management resource 140 distributes a first network policy such as including first access configuration settings to a first wireless access point. The first access configuration settings for use by the first wireless access point control selection, by the first wireless access point, of at least one backhaul amongst multiple backhauls available for use by the first wireless access point.

In processing operation 1520, the communication management resource 140 receives feedback from the first wireless access point. As previously discussed, the feedback may be generated by the first wireless access point, which provides multiple mobile communication devices access to a remote network via the first network policy such as indicating first access configuration settings (first backhaul control settings).

In processing operation 1530, based on the feedback, the communication management resource 140 assigns second access configuration settings (such as associated with a second network policy or another updated first network policy) to the first wireless access point. The second access configuration settings or updated first access configuration settings assigned as a replacement to the first access configuration settings, providing the first wireless access point appropriate support of conveying data communications between the wireless access point in a remote network.

Note again that techniques herein are well suited to facilitate management of different network policies including backhaul control settings assigned to different groupings of wireless access points in a network environment. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

I claim:

1. A method comprising:
distributing first access configuration settings to a first wireless access point, the first access configuration settings operative to control selection, by the first wireless access point, of a backhaul amongst multiple backhauls available for use by the first wireless access point;
receiving feedback from the first wireless access point, the feedback generated based on the first wireless access point providing multiple mobile communication devices access to a remote network via the first access configuration settings; and
based on the feedback, assigning second access configuration settings to the first wireless access point, the second access configuration settings assigned as a replacement to the first access configuration settings.

2. The method as in claim 1, wherein the feedback from the wireless access point indicates a performance of the wireless access point using a selected backhaul amongst the multiple backhauls.

3. The method as in claim 2, wherein the feedback indicates a change in use of the selected backhaul by the first wireless access point to support conveyance of communications associated with the multiple mobile communication devices.

4. The method as in claim 2, wherein the feedback indicates a change in performance of the selected backhaul.

5. The method as in claim 1, wherein the feedback from the wireless access point indicates performances of the wireless access point using a set of selected backhauls amongst the multiple backhauls.

6. The method as in claim 1 further comprising:
communicating the second access configuration settings to the first wireless access point in response to feedback received from a second wireless access point using the multiple backhauls.

7. The method as in claim 1, wherein the first access configuration settings indicate a first ranking of the multiple backhauls.

8. The method as in claim 7, wherein the second access configuration settings indicate a second ranking of the multiple backhauls, the second ranking different than the first ranking.

9. The method as in claim 1 further comprising:
monitoring feedback from the first wireless access point, the feedback indicating a quality of wireless service provided by each of the multiple backhauls;
in response to detecting that the first access configuration settings are not optimized, updating the first access configuration settings; and
providing notification of the availability of the updated first access configuration settings to the first wireless access point.

10. The method as in claim 1, wherein the feedback indicates a data throughput performance associated with a backhaul selected by the first wireless access point; and
wherein the second access configuration settings are assigned to the first wireless access point as the replacement based on the data throughput performance being less than a threshold level.

11. A system comprising:
communication management hardware operative to:
distribute first access configuration settings to a first wireless access point, the first access configuration settings operative to control selection, by the first wireless access point, of a backhaul amongst multiple backhauls available for use by the first wireless access point;
receive feedback from the first wireless access point, the feedback generated based on the first wireless access point providing multiple mobile communication devices access to a remote network via the first access configuration settings; and
based on the feedback, assign second access configuration settings to the first wireless access point, the second access configuration settings assigned as a replacement to the first access configuration settings.

12. The system as in claim 11, wherein the feedback from the wireless access point indicates a performance of the wireless access point using a selected backhaul amongst the multiple backhauls.

13. The system as in claim 12, wherein the feedback indicates a change in use of the selected backhaul by the first wireless access point to support conveyance of communications associated with the multiple mobile communication devices.

14. The system as in claim 12, wherein the feedback indicates a change in performance of the selected backhaul.

15. The system as in claim 11, wherein the feedback from the wireless access point indicates performances of the wireless access point using a set of selected backhauls amongst the multiple backhauls.

16. The system as in claim 11, wherein the management hardware is further operative to:
communicate the second access configuration settings to the first wireless access point in response to feedback received from a second wireless access point using the multiple backhauls.

17. The system as in claim 11, wherein the first access configuration settings indicate a first ranking of the multiple backhauls.

18. The system as in claim 17, wherein the second access configuration settings indicate a second ranking of the multiple backhauls, the second ranking different than the first ranking.

19. The system as in claim 11, wherein the management hardware is further operative to:
monitor feedback from the first wireless access point, the feedback indicating a quality of wireless service provided by each of the multiple backhauls;
in response to detecting that the first access configuration settings are not optimized, update the first access configuration settings; and
provide notification of the availability of the updated first access configuration settings to the first wireless access point.

20. The system as in claim 11, wherein the feedback indicates a data throughput performance associated with a backhaul selected by the first wireless access point; and
wherein the second access configuration settings are assigned to the first wireless access point as the replacement based on the data throughput performance being less than a threshold level.

21. Computer-readable storage hardware having instructions stored thereon, the instructions, when carried out by computer processor hardware, cause the computer processor hardware to:
distribute first access configuration settings to a first wireless access point, the first access configuration settings operative to control selection, by the first wireless access point, of a backhaul amongst multiple backhauls available for use by the first wireless access point;
receive feedback from the first wireless access point, the feedback generated based on the first wireless access point providing multiple mobile communication devices access to a remote network via the first access configuration settings; and
based on the feedback, assign second access configuration settings to the first wireless access point, the second access configuration settings assigned as a replacement to the first access configuration settings.
